(19) United States
(12) Patent Application Publication
(10) Pub. No.: US 2023/0289379 A1
(43) Pub. Date: Sep. 14, 2023

(54) TERMINAL FOR PROVIDING PATENT SEARCH AND CONTROL METHOD THEREFOR, SERVER FOR PROVIDING PATENT SEARCH AND CONTROL METHOD THEREFOR, AND PATENT SEARCH SYSTEM AND CONTROL METHOD THEREFOR

(71) Applicant: Kwang Seok CHOI, Gyeonggi-do (KR)

(72) Inventor: Kwang Seok CHOI, Gyeonggi-do (KR)

(21) Appl. No.: 18/024,053

(22) PCT Filed: Sep. 1, 2021
(86) PCT No.: PCT/KR2021/011763

§ 371 Date: Mar. 1, 2023

(30) Foreign Application Priority Data
Sep. 2, 2020 (KR) 10-2020-0111666

(51) Int. Cl. G06F 16/535; G06F 16/55

(52) U.S. Cl. CPC G06F 16/535; G06F 16/55

(57) ABSTRACT

The present invention relates to a terminal for providing a patent search and a control method therefor, a server for providing patent search and a control method therefor, and a patent search system and a control method therefor, and, to a terminal for providing a patent search and a control method therefor, a server for providing patent search and a control method therefor, and a patent search system and a control method therefor, all of which enable anyone to easily search for an idea that is looked for.

### TECHNICAL FIELD

The present disclosure relates to a terminal for providing a patent search and a control method therefor, a server for providing a patent search and a control method therefor, and a patent search system and a control method therefor.

### BACKGROUND ART

Recently, as the importance of intellectual property rights serving as a means for technology protection has increased, interest in applying patents has increased rapidly. Without distinction between individuals and companies having specialized technologies, taking the interest in the applying of the patents is a trend on the rise.

Currently, patent search systems capable of searching for patents stores world-wide patent document information that has been converted into data. Accordingly, by using the patent search systems, users are able to search for ideas they desire to find.

In a case of searching for a patent, the patent search is mainly performed through operators, parentheses, and writing rules. In addition, the patent search is performed using a complex search formula. However, ordinary people who are not related workers and experts may have a difficulty in using such a patent search method. For this reason, it may be difficult for ordinary people to obtain their desired results by searching for ideas they are thinking of. Not only that reason, children who have low understanding of wording may have difficulty in searching in itself for patents identical to ideas they desire to find.

In general, there are differences between terms commonly used in patent documents and terms used in ordinary life. For this reason, in a case where ordinary people search for the patents by using the terms used in ordinary life, it is difficult to search for patents similar to technologies of which a user is thinking. In addition, even when the user comes up with a specific keyword by oneself for a technology he or she is thinking of and enters the keyword into a search box to search for the technology, it is difficult to accurately match the specific keyword to the related technology, so accurate searching for the technology that the user is thinking of is hard, whereby the user often gives up the searching easily.

Accordingly, it is required to develop a technology enabling anyone to search for an idea and obtain a result thereof easily, regardless of professional knowledge, employment in related fields, or age.

### DOCUMENTS OF RELATED ART

### Patent Document

(Patent Document 1) Korean Patent Application Publication No. 10-2010-0095068

### DISCLOSURE OF INVENTION

### Technical Problem

The embodiment of the present disclosure has been devised to solve the above problems, and an objective of the present disclosure is to provide a terminal for providing a patent search and a control method therefor, a server for providing a patent search and a control method therefor, and a patent search system and a control method therefor, wherein anyone can easily search for ideas they are desired to find, with merely an act of a user selecting classification image information and/or a keyword that are presented through a display unit of a terminal, even when the user does not have expertise in performing a patent search.

### Solution to Problem

A terminal according to one feature of the present disclosure includes: a terminal communication unit for transmitting and receiving information; a terminal memory unit for storing the information; and a terminal control unit for controlling the terminal communication unit and the terminal memory unit, wherein through the terminal communication unit, the terminal control unit is configured to receive classification image information based on a classification system from a server, transmit selected classification image information to the server, receive keyword information from the server, transmit selected keyword information to the server, receive representative image information corresponding to first patent search result information corresponding to the keyword information from the server, and transmit selected representative image information to the server.

A control method of a terminal according to another feature of the present disclosure includes: receiving classification image information based on a classification system from a server; transmitting selected classification image information to the server; receiving keyword information from the server; transmitting selected keyword information to the server; receiving representative image information corresponding to first patent search result information corresponding to the keyword information from the server; and transmitting selected representative image information to the server.

In addition, the control method of the terminal may further include: receiving representative image information corresponding to second patent search result information from the server; receiving question information; transmitting answer information corresponding to the question information; and receiving result information corresponding to the answer information.

A server according to another feature of the present disclosure includes: a server communication unit for transmitting and receiving information; a server memory unit for storing the information; and a server control unit for controlling the server communication unit and the server memory unit, wherein the server control unit is configured to transmit classification image information based on a classification system to a terminal through the server communication unit, obtain keyword information on the basis of selected classification image information through the server memory unit, transmit the keyword information to the terminal through the server communication unit, receive keyword input information from the terminal, obtain first patent search result information corresponding to the keyword input information through the server memory unit, extract representative image information corresponding to the first patent search result information, and transmit the representative image information to the terminal through the server communication unit.

A control method of a server according to another feature of the present disclosure includes: transmitting classification image information based on a classification system to a terminal; receiving selected classification image information from the terminal; obtaining keyword information on the basis of the selected classification image information; transmitting the keyword information to the terminal; receiving keyword input information from the terminal; obtaining first patent search result information corresponding to the keyword input information; extracting representative image information corresponding to the first patent search result information; and transmitting the representative image information to the terminal.

In addition, the control method of the server may further include: obtaining patent document information corresponding to selected representative image information; obtaining second patent search result information based on the patent document information; transmitting representative image information corresponding to the second patent search result information to the terminal; transmitting question information; receiving answer information corresponding to the question information; and transmitting result information corresponding to the answer information.

In addition, the obtaining of the keyword information on the basis of the selected classification image information may include: obtaining lower classification information corresponding to the selected classification image information; extracting keyword information including keywords of patent documents of the lower classification information obtained using pre-stored keyword cluster information; and transmitting the extracted keyword information to the terminal.

In addition, the obtaining of the keyword information on the basis of the selected classification image information may include: obtaining lower classification information corresponding to the selected classification image information; classifying patent documents corresponding to the lower classification information; obtaining keyword cluster information of the classified patent documents; extracting keyword information including keywords appearing the most in the lower classification information on the basis of the keyword cluster information; and transmitting the extracted keyword information to the terminal.

In addition, in the obtaining of the first patent search result information corresponding to the keyword input information, keywords included in a same cluster among keywords included in the keyword input information received from the terminal may be written with an OR combination, and keywords included in other clusters may be written with an AND combination.

In addition, in the transmitting of the result information corresponding to the answer information, additional information of the patent document information including the answer information and received selection patent image information may be transmitted to the terminal when the answer information is YES, and third patent search result information may be obtained and transmitted to the terminal on the basis of the patent document information including the question information and the collectively transmitted representative image information when the answer information is NO.

According to another feature of the present disclosure, there is provided a patent search system including: a terminal for providing a patent search; and a server, wherein the terminal may include: a terminal communication unit for transmitting and receiving information; and a terminal control unit for controlling the terminal communication unit, the terminal control unit may be configured to receive classification image information based on a classification system from the server, transmit selected classification image information to the server, receive keyword information from the server, transmit selected keyword information to the server, receive representative image information corresponding to first patent search result information corresponding to the keyword information from the server, and transmit selected representative image information to the server through the terminal communication unit, the server may include: a server communication unit for transmitting and receiving the information; a server memory unit for storing and outputting the information; and a server control unit for controlling the server communication unit and the server memory unit, and the server control unit may be configured to transmit the classification image information based on the classification system to the terminal through the server communication unit, obtain the keyword information on the basis of the selected classification image information through the server memory unit, transmit the keyword information to the terminal through the server communication unit, receive keyword input information from the terminal, obtain the first patent search result information corresponding to the keyword input information through the server memory unit, extract the representative image information corresponding to the first patent search result information, and transmit the representative image information to the terminal through the server communication unit.

According to another feature of the present disclosure, there is provided a control method of a patent search system including a terminal and a server, which provide a patent search, the control method of the patent search system including: transmitting, by the server, classification image information based on a classification system to the terminal; receiving, by the terminal, the classification image information; transmitting, by the terminal, selected classification image information to the server; obtaining, by the server, keyword information on the basis of the selected classification image information; transmitting, by the server, the keyword information to the terminal; obtaining, by the terminal, keyword input information; transmitting, by the terminal, the keyword input information to the server; obtaining, by the server, first patent search result information on the basis of keywords included in the keyword input information; extracting, by the server, representative image information corresponding to the first patent search result information; and transmitting, by the server, the representative image information to the terminal.

### Advantageous Effects of Invention

As described above, according to the present disclosure, in the terminal for providing a patent search and the control method therefor, the server for providing a patent search and the control method therefor, and the patent search system and the control method therefor, a search range may be narrowed down from a wide range of searching for patents to a range of searching for patents including a concept similar to an idea that a user desires to find on the basis of the image information transmitted and received between components. For this reason, even when a complex search formula is not entered, a patent search result including a similar and/or an identical concept to the idea the user desires to find may be obtained and provided merely by the act of the user selecting the classification image information and/or the keyword, which are presented through the display unit of a terminal.

In addition, according to the present disclosure, in the terminal for providing a patent search and the control method therefor, the server for providing a patent search and the control method therefor, and the patent search system and the control method therefor, an intuitive comparison may be enabled between a patent search result including the similar and/or identical concept and the idea the user desires to find. As a result, anyone can easily search for the ideas they desire to find even when they do not have patent search knowledge required to obtain a patent search result.

### BRIEF DESCRIPTION OF DRAWINGS

FIG. 1 is a block diagram of a terminal according to a preferred exemplary embodiment of the present disclosure.

FIG. 2 is a block diagram of a server according to the preferred exemplary embodiment of the present disclosure.

FIG. 3 is a flowchart of a control method of the terminal according to the preferred exemplary embodiment of the present disclosure.

FIGS. 4 and 5 are flowcharts of a control method of the server according to the preferred exemplary embodiment of the present disclosure.

FIGS. 6 to 8 are flowcharts of a control method of a patent search system according to the preferred exemplary embodiment of the present disclosure.

### MODE FOR THE INVENTION

Although the terms “first”, “second”, etc. may be used herein to describe various components, these components should not be limited by these terms. These terms are only used to distinguish one component from another component. For instance, a first component discussed below could be termed a second component and the second component could also be termed the first component without departing from the scope of rights according to the concept of the present disclosure.

The terms used herein are for the purpose of describing particular exemplary embodiments only and are not intended to be limiting the present disclosure. As used herein, the singular forms are intended to include the plural forms as well, unless the context clearly indicates otherwise. In the present specification, it will be understood that the terms “comprise”, “include”, “have”, etc., when used in this specification, specify the presence of stated features, integers, steps, operations, elements, components, and/or combinations of them, but do not preclude the presence or addition of one or more other features, integers, steps, operations, elements, components, and/or combinations thereof.

The suffix “part” for components used in this specification is given or used interchangeably in consideration of ease of writing the specification, and does not itself have a meaning or role distinct from each other, but may mean a functional or structural combination of hardware for performing a method according to an exemplary embodiment of the present disclosure or software capable of driving the hardware.

A conventional patent search system adopts a configuration in which a user inputs a specific keyword by using a keyword keyboard to search for a patent related to an idea thought by the user. Whereas, a patent search system of the present disclosure adopts a configuration in which a patent related to an idea thought by a user is searched merely by a user's act of selecting classification image information and/or a keyword, which are presented through a display unit of a terminal.

There is a big difference in that the conventional patent search system enables the user to input a keyword related to an idea one by one to search for related patents, whereas the patent search system of the present disclosure enables the user to simply select image information and/or the keyword presented through the terminal to search for the related patents.

Hereinafter, a preferred exemplary embodiment of the present disclosure will be described with reference to the drawings.

The patent search system according to the preferred exemplary embodiment of the present disclosure may be configured to include a terminal 1 and a server 10, which provide a patent search. The patent search system according to the preferred exemplary embodiment of the present disclosure may be implemented with more components or fewer components.

The patent search system according to the preferred exemplary embodiment of the present disclosure including such a structure described above may use patent document information classified according to a specific classification system. The patent search system according to the preferred exemplary embodiment of the present disclosure described below may provide a patent search by using the patent document information classified according to the patent classification system including, for example, IPC classification and CPC classification.

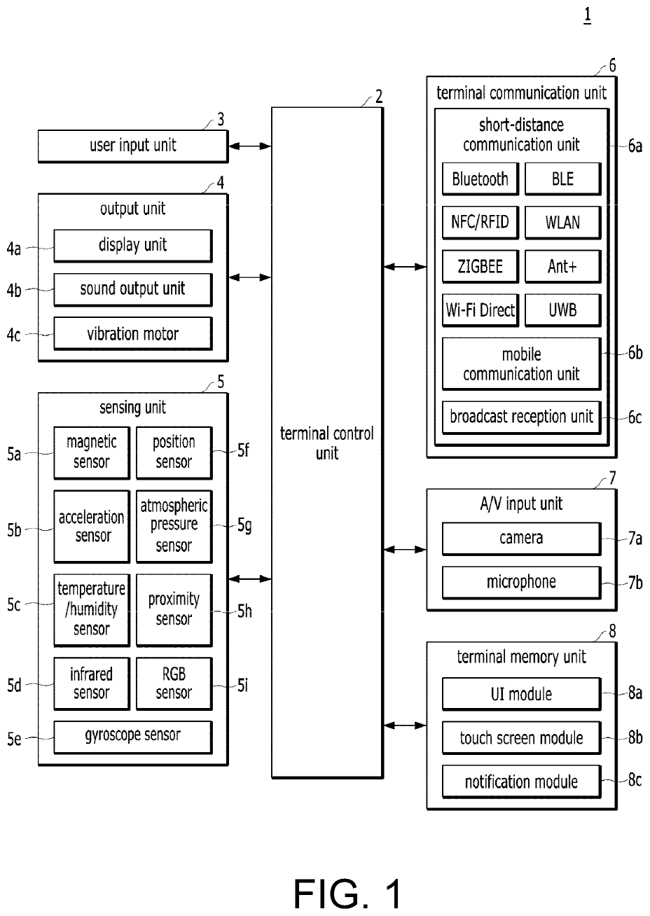

FIG. 1 is a block diagram of the terminal 1 according to the preferred exemplary embodiment of the present disclosure.

The terminal 1 according to the preferred exemplary embodiment of the present disclosure may be referred to as a device, an electronic device, and the like. The terminal 1 according to the preferred exemplary embodiment of the present disclosure may be a smart phone, a tablet PC, a PC, a smart TV, a mobile phone, a Personal Digital Assistant (PDA), a laptop, a media player, a micro server, a Global Positioning System (GPS) device, an electronic book terminal, a digital broadcasting terminal, a navigation device, a kiosk, an MP3 player, a digital camera, a home appliance, and other computing devices, but is not limited thereto.

In addition, the terminal 1 according to the preferred exemplary embodiment of the present disclosure may be a wearable device, which is provided with a display function and data processing function, such as a watch, glasses, a hair band, and a ring. However, the terminal 1 is not limited thereto, and the terminal 1 according to the preferred exemplary embodiment of the present disclosure may include all kinds of devices capable of processing data and providing the processed data.

Referring to FIG. 1, a configuration of the terminal 1 according to the preferred exemplary embodiment of the present disclosure will be described in detail.

The terminal 1 according to the preferred exemplary embodiment of the present disclosure may include a terminal memory unit 8, a terminal communication unit 6, an output unit 4, and a terminal control unit 2. Alternatively, the terminal 1 according to the preferred exemplary embodiment of the present disclosure may include at least one of a terminal memory unit 8, a terminal communication unit 6, an output unit 4, a terminal control unit 2, a sensing unit 5, an Audio/Video (A/V) input unit 7, and a user input unit 3.

The terminal 1 according to the preferred exemplary embodiment of the present disclosure may provide a patent search by communicating with the server 10 according to the preferred exemplary embodiment of the present disclosure.

The terminal memory unit 8 may store programs for processing and controlling of the terminal control unit 2, and may also store information input to the terminal 1 or information output from the terminal 1.

The terminal memory unit 8 may include at least one type of storage media including, a flash memory type memory, a hard disk type memory, a multimedia card micro type memory, a card type memory (e.g., an SD or XD memory, etc.), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk.

Programs stored in the terminal memory unit 8 may be classified into a plurality of modules according to functions thereof, and may be classified into, for example, a UI module 8a, a touch screen module 8b, a notification module 8c, etc.

The UI module 8a may provide a specialized UI, GUI, and the like, interoperating with the terminal 1 for each application.

The touch screen module 8b may detect a user's touch gesture on a touch screen and transmit information about the touch gesture to the terminal control unit 2. The touch screen module 8b according to the exemplary embodiment may recognize and analyze a touch code. The touch screen module 8b may be configured with separate hardware including a controller.

The notification module 8c may generate signals for notifying occurrence of events of the terminal 1. Examples of the events generated in the terminal 1 include call signal reception, message reception, key signal input, schedule notification, and the like. The notification module 8c may output a notification signal in the form of a video signal through a display unit 4a, may output a notification signal in the form of an audio signal through a sound output unit 4b, and may output a notification signal in the form of a vibration signal through a vibration motor 4c. The notification module 8c may generate a signal for outputting guide information on the basis of estimated lane information, as an example.

For each classification system, classification image information representing an uppermost classification to a lowermost classification may be stored in the terminal memory unit 8. The classification image information may be output through the display unit 4a when the patent search system according to the preferred exemplary embodiment of the present disclosure starts to run. The classification image information, including a classification image of the uppermost classification up to a classification image of the lowermost classification, may be sequentially provided through the display unit 4a by the terminal control unit 2.

The output unit 4 may output an audio signal or a video signal or a vibration signal. The output unit 4 may include the display unit 4a, the sound output unit 4b, and the vibration motor 4c.

The display unit 4a displays and outputs information processed by the terminal 1. As an example, the display unit 4a may output an image captured by a camera 7a. In response to a user's input, the display unit 4a may display a user interface for executing an operation related to the response.

The display unit 4a may display and output information stored in the terminal memory unit 8. The display unit 4a may display and output pieces of information (specifically, image information, keyword information, and patent document information), which are received from the server 10.

The sound output unit 4b outputs audio data that is received from the terminal communication unit 6 or stored in the terminal memory unit 8. In addition, the sound output unit 4b outputs sound signals (e.g., call signal reception sound, message reception sound, and notification sound) related to functions performed by the terminal 1.

In general, the terminal control unit 2 controls overall operations of the terminal 1. For example, the terminal control unit 2 may generally control the user input unit 3, the output unit 4, the sensing unit 5, the terminal communication unit 6, the A/V input unit 7, and the like by executing the programs stored in the terminal memory unit 8.

In a case where a patent search formula is stored in the terminal memory unit 8, the terminal control unit 2 may substitute keywords included in keyword input information input through the display unit 4a into the patent search formula stored in the terminal memory unit 8. The terminal control unit 2 may also transmit the patent search formula, into which the keywords according to the keyword input information are substituted, to the server 10 through the terminal communication unit 6.

The sensing unit 5 may detect a state of the terminal 1 or a state around the terminal 1, and transmit the detected information to the terminal control unit 2.

The sensing unit 5 may include at least one of a magnetic sensor 5a, an acceleration sensor 5b,
a temperature/humidity sensor 5c, an infrared sensor 5d, a gyroscope sensor 5e, a position sensor (e.g., a GPS) 5f, an atmospheric pressure sensor 5g, a proximity sensor 5h, and an RGB sensor 5i, but is not limited thereto. Since those skilled in the art can intuitively infer the function of each sensor from its name, a detailed description thereof will be omitted.

The terminal communication unit 6 may include one or more components that allow the terminal 1 to communicate with other devices (not shown). The other devices may be sensing devices or computing devices similar to the terminal 1, but are not limited thereto. For example, the terminal communication unit 6 may include a short-distance communication unit 6a, a mobile communication unit 6b, and a broadcast reception unit 6c.

The short-distance communication unit may include a Bluetooth communication unit, a Bluetooth Low Energy (BLE) communication unit, a Near Field Communication unit, a WLAN (Wi-Fi) communication unit, a Zigbee communication unit, an infrared Data Association (IrDA) communication unit, a Wi-Fi Direct (WFD) communication unit, an ultra-wideband (UWB) communication unit, an Ant+ communication unit, and the like, but is not limited thereto.

The mobile communication unit 6b transmits and receives wireless signals with at least one of a base station, an external terminal, and a server, which are on a mobile communication network. Here, the wireless signals may include voice call signals, video call signals, or various types of data according to transmission/reception of text/multimedia messages.

The broadcast reception unit 6c receives broadcast signals and/or broadcast-related information from the outside through broadcast channels. The broadcast channels may include satellite channels and terrestrial channels. Depending on the implementation example, the terminal 1 may not include the broadcast reception unit 6c.

The Audio/Video (A/V) input unit 7 is for inputting audio signals or video signals, and may include a camera 7a and a microphone 7b.

The camera 7a may obtain an image frame such as a still image or a moving image through an image sensor in a video call mode or a photographing mode. The images captured through the image sensor may be processed through the terminal control unit 2 or a separate image processing unit (not shown).

The microphone 7b receives external sound signals and processes the external sound signals into electrical voice data. For example, the sound signals may be received from a user or an external device of the microphone 7b. The microphone 7b may receive a user's voice input. The microphone 7b may use various noise cancellation algorithms for removing noise generated in the process of receiving sound signals from the outside.

The user input unit 3 refers to a means through which a user inputs data for controlling the terminal 1. For example, the user input unit 3 may include a key pad, a dome switch, and a touch pad (in a contact capacitance method, a pressure resistive film method, an infrared sensing method, a surface ultrasonic conduction method, an integral type tension measuring method, a piezo-electric effect method, etc.), a jog wheel, a jog switch, and the like, but is not limited thereto.

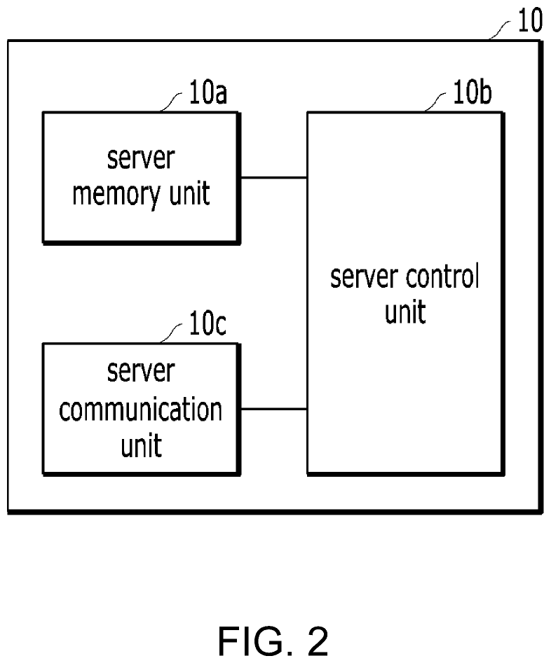

FIG. 2 is a block diagram of the server 10 according to the preferred exemplary embodiment of the present disclosure.

As shown in FIG. 2, the server 10 according to the preferred exemplary embodiment of the present disclosure may include a server memory unit 10a, a server communication unit 10c, and a server control unit 10b. Since the description of each component of the server 10 according to the preferred exemplary embodiment of the present disclosure is the same as the description for the terminal memory unit 8, the terminal communication unit 6, and the terminal control unit 2 of the terminal 1 according to the preferred exemplary embodiment of the present disclosure, detailed descriptions thereof will be omitted.

Patent document information for each classification may be pre-stored in the server memory unit 10a. The patent document information for each classification may be patent document information that is classified according to a classification system and is classified by detailed classifications of the corresponding classification system.

Describing in detail, as an example, the patent document information may be classified and stored in at least one classification system among classification systems including: a patent classification system including IPC classification, CPC classification, F-term classification, FI classification, and US Class classification; a design classification system including Locarno classification; and a trademark (product) classification system including NICE classification.

More specifically, each classification system may include detailed classifications including upper classifications and lower classifications, which correspond to the upper classifications, for each classification system. The detailed classifications of the classification system may be subdivided. For example, the uppermost classification of the detailed classifications of the patent classification system may consist of a first to eighth uppermost classification. A plurality of lower classifications corresponding to each uppermost classification may be included in each of the uppermost classifications. For example, in a first lower classification corresponding to the first uppermost classification, a plurality of second lower classifications more subdivided and corresponded to the first lower classification may be included. The first lower classification may be an upper classification corresponding to second lower classifications, and the upper classification corresponding to the first lower classification may be the first uppermost classification. In an n-th lower classification, a plurality of lowermost classifications corresponding to the n-th lower classification (where n is a natural number) may be included. Patent document information for each classification may be pre-stored in the server memory unit 10a for each classification system described-above and for each detailed classification of the corresponding classification system.

Classification image information representing detailed classifications may be stored in the server memory unit 10a for each classification system. More specifically, the classification image information representing each of the uppermost classifications up to lowermost classifications, which are included in the detailed classifications, may be stored.

The server control unit 10b may transmit classification image information of detailed classifications to the terminal 1. Specifically, the server control unit 10b may first transmit classification image information of the plurality of uppermost classifications to the terminal 1 and receive transmission of classification image information of lower classifications corresponding to selected one uppermost classification. The server control unit 10b may sequentially transmit, to the terminal 1, the classification image information of lower classifications corresponding to at least one classification selected from among detailed classifications.

The server control unit 10b may obtain patent document information of the classification corresponded to and based on the classification image information of the detailed classifications received from the terminal 1. This may be performed based on the patent document information for each classification pre-stored in the server memory unit 10a. The server control unit 10b may preferably extract keywords appearing the most in the classification corresponding to the classification image information received from the terminal 1. The server control unit 10b may extract the keywords appearing the most for each classification by using keyword cluster information stored in the server memory unit 10a. As an example, the server control unit 10b may extract the keywords through data mining.

The keyword cluster information composed of keywords included in patent documents may be stored in the server memory unit 10a. The keywords having similar meanings may be classified and stored as the same cluster information. In addition, as an example, similar keywords in an imaged form may be inherently included in the keywords included in the keyword cluster information. The keyword cluster information may be stored in the form of a table classified according to detailed classifications and according to identification numbers of patent document information (e.g., patent document registration numbers and/or publication numbers, etc.).

A specific search formula may be pre-stored in the server memory unit 10a. Preferably, the specific search formula may be configured to include: a “+” operator meaning “OR” that combines keywords having similar meanings; a “*” operator meaning “AND” that combines keywords having different meanings; and parentheses. The “+” operator is an operator that searches to include at least one of the keywords before and after the operator thereof, and the “*” operator is an operator that searches to include both keywords before and after the operator thereof. In addition, a “NOT” operator is an operator that searches not to include a keyword after the operator thereof, an “ADJ” operator is an operator that searches for keywords that are entered before and after the operator thereof and are present in order within a specific distance, and a “NEAR” operator is an operator that searches for keywords that are entered before and after the operator thereof and are present within a specific distance regardless of an order. Such operators may include those known prior to application of the present disclosure.

The server control unit 10b may write keywords included in keyword input information received from the terminal 1 in a specific search formula stored in the server memory unit 10a. In this case, keywords included in a cluster included in the same cluster may be written with an OR combination, and keywords included in a different cluster may be written with an AND combination. The server control unit 10b may perform a search on the patent document information stored in the server memory unit 10a by using the keywords written in the patent search formula. A searched result using the patent search formula may be a first patent search result. Accordingly, first patent search result information may be information including patent documents searched using the patent search formula.

From the patent documents according to the first patent search result, the server control unit 10b may extract representative image information, which represents each patent document. The representative image information may be at least one of drawings included in each patent document, and may be images of at least some of components included in the drawings. Alternatively, the representative image information may be a specific image for each patent document included in the patent document information pre-stored in the server memory unit 10a.

The representative image information may include, as metadata, names of components described in claims and/or in the detailed description of the invention in the patent document information including the representative image information. Accordingly, the server control unit 10b may obtain the names of the components on the basis of the representative image information and use the names for patent search. Specifically, the server control unit 10b may perform a patent search by writing the names of the components as keywords in a patent search formula.

The server control unit 10b may transmit the extracted representative image information to the terminal 1 through the server communication unit 10c. At least one or more pieces of representative image information displayed through the terminal 1 may be selected by a user. The server control unit 10b may receive the selected representative image information and obtain patent document information corresponding to the representative image information. The representative image information is extracted from the patent documents. Accordingly, the server control unit 10b may obtain the patent document information including the representative image information. The patent document information means a patent specification. Accordingly, the patent document information may include the entire content including invention titles, abstracts, claims, technical fields, technical problems, technical solutions, advantageous effects, background arts, and drawings. In addition, the patent document information including the representative image information may include patent document information including the selected representative image information received from the terminal 1, i.e., the citing and/or cited patent document information of the patent specification.

Meanwhile, even when the patent document information pre-stored in the server memory unit 10a is not classified and stored by classification, the server control unit 10b may also classify the patent document information corresponding to the classification image information on the basis of the classification image information received from the terminal 1.

The patent search system of the present disclosure is characterized by tracking and searching for an idea being thought by a user merely by a user's selection act, and may be configured to include: limiting a search target range through the user's selection act by using a hierarchical classification system of patent documents; and extracting similar patents through the user's selection act in the limited search target range.

The patent search system of the present disclosure first limits a search target range through a user's selection act, and then performs extracting similar patents through the user's selection act in the limited search target range.

Here, the limiting of the search target range by using the hierarchical classification system of the patent documents is a step of narrowing down the search target range by way of including receiving a plurality of pieces of classification image information based on the classification system from the server 10 and transmitting the selected classification image information selected from the plurality of presented pieces of classification image information. A user using the patent search system of the present disclosure may narrow down the search target range by selecting any one classification image related to the idea of which he or she is thinking among the plurality of pieces of classification image information provided from the terminal 1.

In addition, when the limiting of the search target range is completed, extracting similar patents from the limited search target range is performed. The extracting of the similar patents in the limited search target range is a step of extracting the similar patents by using keyword information extracted from the pieces of patent document information belonging to a finally selected classification. By performing a search for the similar patents on the basis of the patent document information selected by the user among the plurality of pieces of patent document information provided from the terminal 1, a patent related to the idea of which the user is thinking may be tracked and searched for.

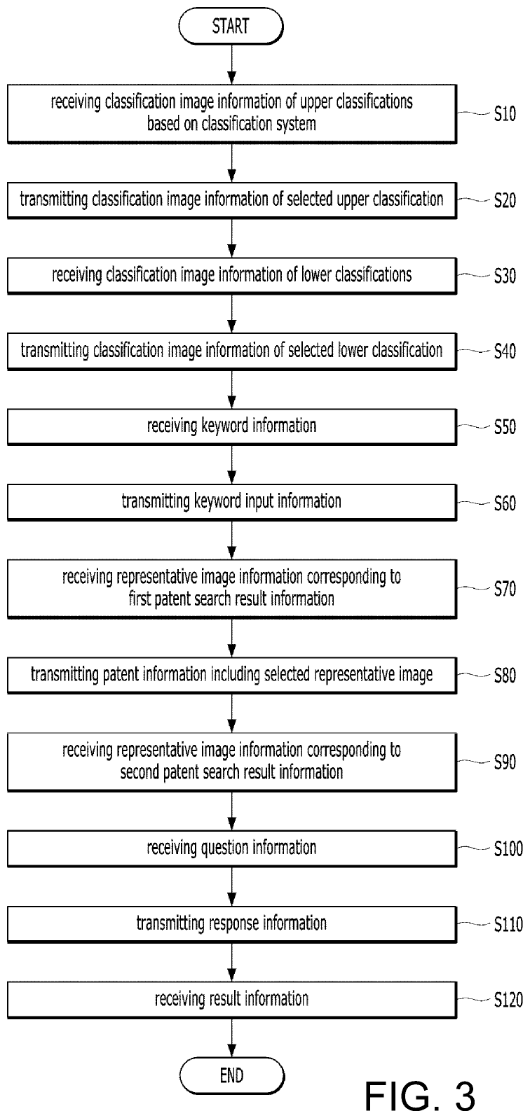

FIG. 3 is a flowchart of the control method of the terminal 1 according to the preferred exemplary embodiment of the present disclosure.

The control method of the terminal 1 according to the preferred exemplary embodiment of the present disclosure may be configured to include: receiving classification image information based on a classification system from a server 10; transmitting selected classification image information to the server 10; receiving keyword information from the server 10; transmitting selected keyword information to the server 10; receiving representative image information corresponding to first patent search result information corresponding to the keyword information from the server 10; and transmitting selected representative image information to the server 10.

As shown in FIG. 3, in step S10, the terminal 1 may receive classification image information based on the classification system. The classification image information may be composed of specific images representing respective classifications.

As an example, the terminal 1 may receive classification image information based on the patent classification system.

The classification image information may be image information corresponding to each of upper classifications and lower classifications of the patent classification system. In detail, the patent classification system may be divided by means of a section of an uppermost classification, a subsection that is a lower classification of the section, a class that is a lower classification of the subsection, and a subclass that is a lower classification of the class. As an example, classification image information may include first classification image information corresponding to the section, second classification image information corresponding to the subsection, third classification image information corresponding to the class, and fourth classification image information corresponding to the subclass.

A plurality of sections, a plurality of subsections, a plurality of classes, and a plurality of subclasses in the patent classification system may be configured. Accordingly, the first to fourth classification image information corresponding to respective classifications may include a plurality of pieces of image information.

The terminal 1 according to the preferred exemplary embodiment of the present disclosure may sequentially receive pieces of representative classification image information respectively corresponding to entities from the sections of the uppermost classifications up to the subclasses of the lowermost classifications.

In step S10, a terminal 1 may receive classification image information of sections that are uppermost classifications based on a patent classification system from a server 10. Specifically, the terminal 1 may receive first classification image information from the server 10. The first classification image information corresponding to the sections may be displayed through a display unit 4a. By selecting at least one piece of the first classification image information of the sections displayed through the display unit 4a, the terminal 1 may obtain first classification image information of a selected section.

In step S20, the terminal 1 may transmit the selected classification image information to the server 10. As an example, the terminal 1 may transmit the first classification image information of the obtained section to the server 10.

In step S30, the terminal 1 may receive classification image information of subsections that are lower classifications of the section from the server 10. As an example, the terminal 1 may receive second classification image information corresponding to the subsections.

In step S40, the terminal 1 may transmit second classification image information of a selected subsection to the server 10. How many levels of classifications to be divided into from the uppermost classifications to the lowermost classifications may vary depending on information pre-stored in the server memory unit 10a. Steps S10 to S40 describe only up to two-level classification among those classification levels, but hierarchical classification levels may be three or more levels.

The terminal 1 according to the preferred exemplary embodiment of the present disclosure may perform steps S10 to S40 up to the lowermost classifications stored in the server memory unit 10a, thereby being able to sequentially transmit the classification image information of the upper classifications and lower classifications thereof to the server 10. More specifically, information from the classification image information of the uppermost classifications (e.g., the first classification image information of the sections) up to the classification image information of the lowermost classifications (e.g., the fourth classification image information of the subclasses) may be sent to the server 10.

In step S50, the terminal 1 may receive keyword information from the server 10.

The keyword information may be information pre-stored in the server memory unit 10a.

The keyword information may be information including keywords appearing the most in a classification corresponding to classification image information of a final classification transmitted from the terminal 1.

The keyword information may be extracted from patent documents belonging to the finally selected classification. After extracting keywords included in patent document information by using data mining techniques from the patent document information of the patent documents belonging to the finally selected classification, a frequency of occurrence is calculated for each keyword, so as to assign a high priority to each keyword having a high frequency of occurrence, whereby the keyword information may be organized.

After extracting keywords for each field item (for invention titles, abstracts, claims, technical fields, technical problems, technical solutions, advantageous effects, background arts, and drawings) of the pieces of patent document information in the finally selected classification, the keyword information may be organized by calculating the frequency of occurrence of each keyword by field item.

The keyword information may be organized by combining the keyword information extracted for each field item of the pieces of patent document information in the finally selected classification. As the exemplary embodiment, the keyword information may be organized by combining keyword information extracted from an invention title among the field items of the patent document information and keyword information extracted from a technical problem among the field items of the patent document information.

The keyword information may be keyword information that has recently become an issue in the finally selected classification. As the exemplary embodiment, the keyword information may be keyword information most frequently searched for in a specific period, such as a range of the last 1 month, a range of 3 months, a range of 6 months, a range of 1 year, a range of 3 years, a range of 5 years, and a range of 10 years in the finally selected classification.

Through the display unit 4a, the terminal 1 may display the received keyword information. The terminal 1 may obtain a user input signal for at least one or more pieces of displayed keyword information. Here, the user input signal is an input signal according to a selection act performed by a user selecting some of the presented keyword information, rather than an input signal according to a keyword input method through a keyword keyboard. The user input signal may be an input signal according to the selection act by a drag and drop method. However, the user's selection act may also include other types of selection acts in addition to the drag and drop method.

In step S60, the terminal 1 may transmit the selected keyword information to the server 10.

In step S70, the terminal 1 may receive, from the server 10, representative image information corresponding to first patent search result information corresponding to the keyword information transmitted to the server 10. The first patent search result information may be result information obtained by performing a search on the patent document information stored in the server memory unit 10a by using the keyword information selected by the user. The representative image information corresponding to the first patent search result information is representative image information representing each piece of the patent document information included in the first patent search result information, and may be any one of patent drawings attached to each of patent documents. The terminal 1 may display the representative image information representing the patent document information included in the first patent search result information through the display unit 4a. The terminal 1 may obtain a user selection signal for at least one or more pieces of displayed representative image information.

In step S80, the terminal 1 may transmit the selected representative image information to the server 10.

In step S90, the terminal 1 may receive representative image information corresponding to second patent search result information from the server 10.

The second patent search result information may be patent document information obtained, in the previous steps, by transmitting the selected representative image information by the terminal 1 to the server 10 and performing a patent search on the basis of the patent document information including the representative image information received by the server 10. The second patent search result information is information on the patent documents similar to the patent documents selected in the previous step. To this end, the second patent search result information may be searched from the patent document information stored in the server memory unit 10a on the basis of the patent document information selected by the user in the previous step.

As the exemplary embodiment, the second patent search result information may be result information searched from the pieces of patent document information stored in the server memory unit 10a by using an invention title, as a keyword, among the field items of the patent document information selected in the previous step. In this case, the second patent search result information may include patent documents searched in the field for invention titles of the pieces of patent document information stored in the server memory unit 10a by using the invention title, as the keyword, among the field items of the patent document information selected in the previous step.

Alternatively, the second patent search result information may be result information searched from the pieces of patent document information stored in the server memory unit 10a by using a component name shown in a drawing, as a keyword, among the field items of the patent document information selected in the previous step. In this case, the second patent search result information may include the patent documents searched in the field for invention titles of the pieces of patent document information stored in the server memory unit 10a by using the component name shown in the drawing, as the keyword, among the field items of the patent document information selected in the previous step.

Since the second patent search result information is the search result of patent documents obtained by using the field items of the patent document information selected by the user in the previous step, there is provided a strong point that patent search is performed by tracking the flow of user's thoughts. The user will select a patent document similar to an idea of which he or she is thinking, so there is a high possibility that at least one of the field items of the selected patent document information includes information related to the idea the user has in mind. Accordingly, when a patent document is searched using the field items of the patent document information selected by the user in the previous step, a more accurate patent search may be performed because the flow of the user's thoughts is tracked.

The terminal 1 may receive representative image information corresponding to the second patent search result information from the server 10.

The terminal 1 may display a plurality of pieces of representative image information corresponding to the second patent search result information and obtain user selection signals for at least one or more of the plurality of pieces of representative image information that is displayed.

Steps S80 and S90 may be iteratively performed. For example, the terminal 1 transmits selected first representative image information to the server 10, the server 10 transmits, to the terminal 1, the plurality of pieces of patent document information obtained by performing a patent search on the basis of patent document information including the received first representative image information, and the user selects second representative image information from the pieces of representative image information of the plurality of pieces of patent document information. Thereafter, the terminal 1 transmits the selected second representative image information to the server 10, the server 10 transmits, to the terminal 1, the plurality of pieces of patent document information obtained by performing a patent search on the basis of patent document information including the received second representative image information, and the user selects third representative image information from the pieces of representative image information of the plurality of pieces of patent document information. Thereafter, the terminal 1 transmits the selected third representative image information to the server 10. Next, the server 10 transmits, to the terminal 1, the plurality of pieces of patent document information obtained by performing a patent search on the basis of patent document information including the received third representative image information. Then, the user selects fourth representative image information from the pieces of representative image information of the plurality of pieces of patent document information. Such a process may be iteratively performed. As such, since the patent searches are performed by following the flow of the user's thoughts through the configuration of searching for similar patent documents on the basis of the representative image information selected in the previous step, patents related to the idea the user has in mind may be extracted more quickly.

The terminal 1 may transmit a specific number of n-th order pieces (n is a natural number) of representative image information to the server 10 by iteratively performing steps S80 and S90.

In step S100, the terminal 1 may receive question information. Step S100 may be performed when the terminal 1 iteratively performs steps S80 and S90 and transmits representative image information by a predetermined specific number to the server 10. Describing in detail, the server 10 may be set to transmit the question information when the number of pieces of representative image information transmitted by the terminal 1 reaches the specific number. The specific number may be set to any number. For example, a specific number of 15 may be set in the server 10. Here, the specific number is preferably set to a number that may provide sufficient visibility to the user when the representative image information is displayed through the display unit 4a. The terminal 1 may transmit, for example, 15 pieces of representative image information selected by user selection signals to the server 10 by iteratively performing steps S80 and S90. The 15 pieces of representative image information selected by the user may be displayed through the display unit 4a of the terminal 1. The pieces of representative image information may be displayed all at once on one screen of the display unit 4a, or may be displayed separately on another screen.

When the number of pieces of representative image information transmitted from the terminal 1 to the server 10 reaches the specific number preset in the server 10, the terminal 1 may receive question information from the server 10. In step S100, the terminal 1 may receive the question information for checking whether a patent search result similar and/or identical to the idea the user desires to find has been obtained.

The question information may be organized in various ways. As an example, in step S100, the terminal 1 may receive and display whether yes or no information along with sentence information “Is there an idea you thought of here?” as the question information. The yes-or-no information may be information including “YES” or “NO”. Accordingly, the question information may include the sentence information and yes-or-no information. The question information may be displayed in a pop-up window, and a form in which the question information is displayed is not limited thereto.

In step S100, the terminal 1 receives the question information and iteratively performs steps S80 and S90, so as to receive and collectively display the specific number of pieces of representative image information transmitted to the server 10. For example, in step S100, the terminal 1 may receive the question information, and collectively receive and display the 15 pieces of representative image information.

In step S110, the terminal 1 may obtain answer information on the basis of a user selection signal for the question information and transmit the answer information to the server 10.

In step S120, the terminal 1 may receive result information corresponding to the answer information from the server 10.

Specifically, in step S110, when the answer information is YES, the terminal 1 may additionally obtain user selection signals for at least one of the 15 pieces of representative image information collectively displayed. In other words, in step S110, the terminal 1 may obtain the answer information and selection patent image information by additionally obtaining the user selection signals for at least one of the collectively displayed representative image information. The selection patent image information may be the representative image information selected by the user selection signals. Then, the terminal 1 may transmit the answer information of YES and the selection patent image information to the server 10. The terminal 1 may receive additional information about the patent document information including the selection patent image information. Here, the additional information may include image information of other drawings included in the patent document information including the selection patent image information transmitted from the terminal 1 to the server 10. In addition, the additional information may include detailed content (for example, the items including abstracts, technical problems, detailed descriptions of the inventions, etc.) included in the patent document information including the selection patent image information transmitted from the terminal 1 to the server 10.

Accordingly, in a case where the answer information is YES, the result information received by the terminal 1 from the server 10 in step S120 may be the additional information of the patent document information including the selection patent image information.

Meanwhile, in step S120, in a case where the answer information transmitted from the terminal 1 to the server 10 is NO, the terminal 1 may iteratively perform steps S80 and S90 again. That is, in step S80, the terminal 1 may transmit the representative image information selected in the previous step to the server 10. In step S90, the terminal 1 may receive representative image information corresponding to second patent search result information from the server 10.

Unlike this, in step S120, in the case where the answer information transmitted from the terminal 1 to the server 10 is NO, the terminal 1 may receive, from the server 10, representative image information corresponding to third patent search result information searched based on the patent document information including the representative image information collectively displayed on the terminal 1.

The third patent search result information is patent document information searched for based on the patent document information including the collectively displayed representative image information. The pieces of representative image information collectively displayed are not the same as the idea thought by the user but are similar patents, so when a follow-up patent search is performed using this information, more effective search results may be obtained.

The third patent search result information may be obtained by extracting at least one keyword to be used for a search from patent document information corresponding to each piece of the representative image information collectively displayed. The server control unit 10b extracts at least one commonly used common keyword from the patent document information corresponding to the collectively displayed representative image information, and may obtain the third patent search result information by using the at least one common keyword.

As the exemplary embodiment, the at least one commonly used common keyword is extracted from the invention title part of the patent document information corresponding to the collectively displayed representative image information, so that the third patent search result information may be obtained using the at least one common keyword.

Alternatively, as the exemplary embodiment, at least one or more common keywords commonly used in components shown in a drawing are extracted from among the field items of the patent document information corresponding to the collectively displayed representative image information, so that the third patent search result information may be obtained using the at least one common keyword. The reason is that since the user selects the representative image information with the naked eye, there is a high possibility that the components shown in the drawing include a component similar to the idea thought by the user.

The third patent search result information may merely receive representative image information of the patent document information excluding the collectively displayed representative image information. This is so devised in consideration of the fact that there is no patent identical to the idea the user has in mind in the collectively displayed representative image information, and may be implemented by a process of filtering redundantly searched patent document information in the server 10.

Then, the terminal 1 may return to step S100 and iteratively perform steps S100 to S120.

Describing in more detail, in step S120, in a case where the answer information transmitted from the terminal 1 to the server 10 is NO, the terminal 1 may receive, from the server 10, the representative image information corresponding to the third patent search result information searched based on the patent document information including the representative image information collectively displayed on the terminal 1. Then, the terminal 1 may receive the question information of step S100 again and perform step S120 on the basis of the answer information of step S110.

In step S120, in the case where the terminal 1 transmits the answer information of NO to the server 10, the result information corresponding to the answer information may be representative image information corresponding to third patent search result information newly searched in the server 10 on the basis of patent document information including the representative image information collectively displayed on the terminal 1. Accordingly, the terminal 1 may repeatedly receive and display the representative image information corresponding to the newly searched patent search result until the patent document information including the same concept as the idea thought by the user is provided.

The terminal 1 may receive search completion confirmation information from the server 10 after displaying final information of the result information. As an example, the terminal 1 configured using a smart phone may recognize, as the final information, the last page among pages displaying the result information. After displaying the last page through the display unit 4a, the terminal 1 may transmit a final information display signal to the server 10. Then, the terminal 1 may receive the search completion confirmation information from the server 10 that has received the final information display signal. The search completion confirmation information may include yes-or-no information and sentence information in the form of “Is this the patent you are searching for?”, as an example.

In the case where the terminal 1 obtains NO among the yes-or-no information of the search completion confirmation information, the terminal 1 may re-perform the same process as in the case of transmitting the NO answer in step S120 described above.

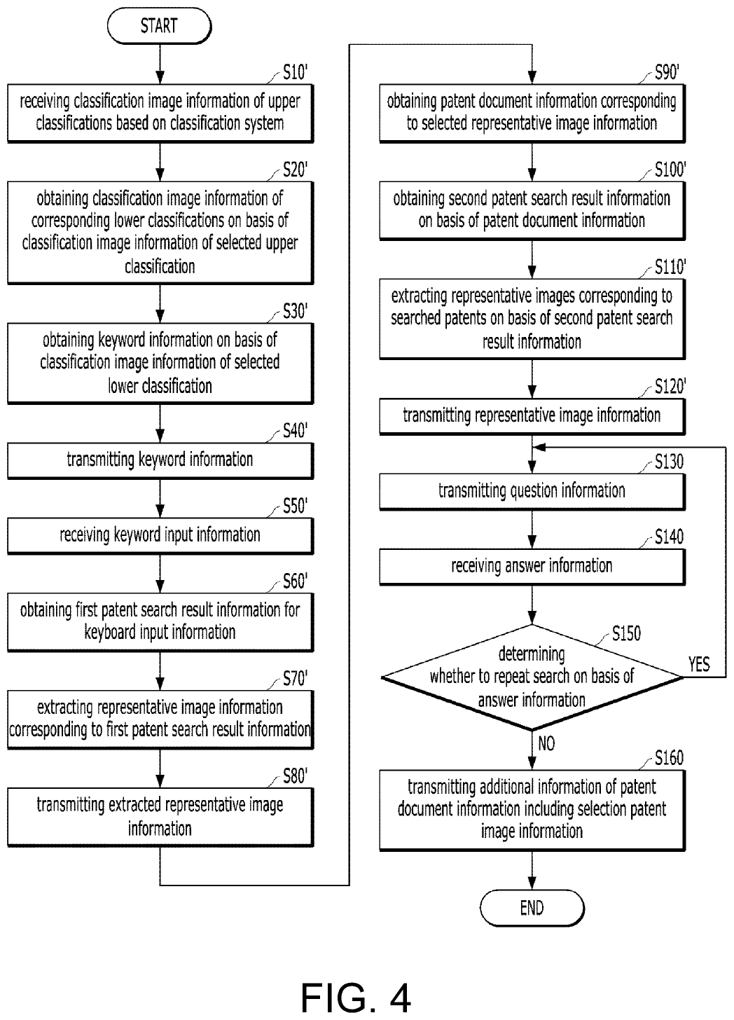

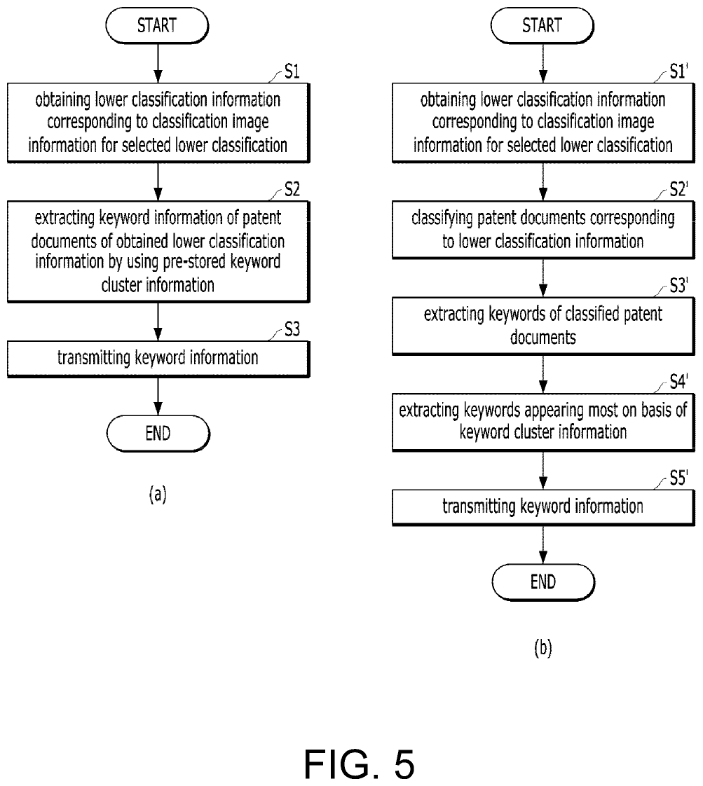

FIGS. 4 and 5 are flowcharts of a method of controlling the server 10 according to the preferred exemplary embodiment of the present disclosure.

As shown in FIG. 4, in step S10′, a server 10 may transmit upper classification image information based on a classification system to a terminal 1. As an example, the server 10 according to the preferred exemplary embodiment of the present disclosure may transmit the upper classification image information based on the patent classification system to the terminal 1.

The server 10 may first transmit classification image information of uppermost classifications by using classification image information of detailed classifications pre-stored in a server memory unit 10a. Specifically, the server 10 may transmit the classification image information representing a plurality of pieces of uppermost classifications included in the classification system to the terminal 1. As an example, the server 10 may transmit first classification image information corresponding to sections that are the uppermost classifications of the patent classification system.

In step S20′, the server 10 may receive selected classification image information from the terminal 1. Specifically, the server 10 may receive first classification image information of one section selected from among the first classification image information of the plurality of sections displayed on the terminal 1. The server 10 may obtain second classification image information corresponding to subsections that are lower classifications of the section on the basis of the first classification image information of the section received from the terminal 1.

By iteratively performing steps S10′ and S20′, the server 10 may obtain at least one piece of classification image information from among the classification image information of a plurality of lowermost classifications.

As an example, the server 10 may transmit the second classification image information of the subsections obtained in step S20′ described above to the terminal 1, and receive second classification image information of one subsection selected through step S10′. Again in step S20′, the server 10 may obtain third classification image information corresponding to classes that are lower classifications of the subsection on the basis of the received second classification image information of the subsection. The server 10 may transmit the obtained third classification image information of the classes to the terminal 1 and receive third classification image information of one class selected through step S10′ once more. Then, in step S20′, the server 10 may obtain fourth classification image information corresponding to subclasses that are the lowermost classifications on the basis of the received third classification image information of the class. The server 10 may transmit the obtained fourth classification image information of the subclasses to the terminal 1, and receive fourth classification image information of one subclass selected through step S10′.

In step S30′, the server 10 may obtain keyword information on the basis of the selected classification image information.

FIG. 5(a) is a flowchart of a first exemplary embodiment of obtaining keyword information by the server 10 in step S30′ on the basis of the selected classification image information. The first exemplary embodiment may preferably be performed in a case where patent document information for each classification is stored in the server memory unit 10a.

As shown in FIG. 5(a), in step S1, as an example, the server 10 may obtain lower classification information corresponding to finally selected classification image information. The classification image information may be classified for each detailed classification and stored in the server memory unit 10a. Accordingly, the server control unit 10b may obtain lower classification information corresponding to the finally selected lowermost classification image information by using the classification image information stored for each detailed classification in the server memory unit 10a.

In step S2, the server 10 may extract keyword information including keywords of patent documents of the lower classification information obtained in step S1 by using keyword cluster information pre-stored in the server memory unit 10a. In this case, the server 10 may preferably perform comparison between each of the number of keywords included in each piece of cluster information organized by way of classifying keywords having similar meanings among keywords included in the keyword cluster information. Then, the server 10 may determine keywords of the cluster information having a large number of keywords as keywords appearing the most, and extract the keyword information including the determined keywords. In addition, the server 10 may extract not only the keywords appearing the most, but also keyword cluster information of a classification corresponding to the lower classification information obtained in step S1.

The keyword information may be information including keywords appearing the most in a classification corresponding to classification image information of a final classification transmitted from the terminal 1.

The keyword information may be extracted from patent documents belonging to the finally selected classification. The keyword information may be organized by calculating a frequency of occurrence for each keyword, so as to assign a high priority to each keyword having a high frequency of occurrence, after extracting keywords included in patent document information by using data mining techniques from the patent document information of the patent documents belonging to the finally selected classification.

The keyword information may be organized by calculating respective frequencies of occurrence of keywords for each field item, after extracting the keywords for each field item (for invention titles, abstracts, claims, technical fields, technical problems, technical solutions, advantageous effects, background arts, and drawings) of the pieces of patent document information in the finally selected classification.

The keyword information may be organized by combining the keyword information extracted for each field item of the pieces of patent document information in the finally selected classification. As the exemplary embodiment, the keyword information may be organized by combining keyword information extracted from an invention title among the field items of the patent document information and keyword information extracted from a technical problem among the field items of the patent document information.

The keyword information may be keyword information that has recently become an issue in the finally selected classification. As the exemplary embodiment, the keyword information may be keyword information most frequently searched for in a specific period, such as a range of the last 1 month, a range of 3 months, a range of 6 months, a range of 1 year, a range of 3 years, a range of 5 years, and a range of 10 years in the finally selected classification.

In step S3, the server 10 may transmit, to the terminal 1, the keyword information including, for example, the keyword cluster information of the classification corresponding to the keywords appearing the most and the lower classification information obtained in step S1.

FIG. 5(b) is a flowchart of a second exemplary embodiment of obtaining keyword information by the server 10 in step S30′ on the basis of the selected classification image information. The second exemplary embodiment may be performed in a case where the patent document information stored in the server memory unit 10a is not classified and stored for each classification.

As shown in FIG. 5(b), as an example, in step S1′, the server 10 may obtain lower classification information corresponding to the finally selected classification image information. The obtaining of the lower information may be performed in the same manner as that in step S1 of the first exemplary embodiment shown in FIG. 5(a).

In step S2′, the server 10 may classify patent documents corresponding to the lower classification information. Specifically, the server 10 may classify the patent documents corresponding to the lower classification information obtained in step S1′ by referring to detailed classifications included in each patent document included in the patent document information stored in the server memory unit 10a.

In step S3′, the server 10 may obtain keyword cluster information of the patent documents classified in step S2′. Specifically, the server 10 may generate and store the keyword cluster information by extracting keywords included in the patent documents classified in step S2′. In this case, the server 10 may classify and store, as the same cluster information, keywords having similar meanings among keywords included in the keyword cluster information. The server 10 may obtain the keyword cluster information of the classified patent documents by performing such a process.

In step S4′, the server 10 may extract keyword information including keywords appearing the most in the lower classification information obtained in step S1′ on the basis of the keyword cluster information. The server 10 may classify the keywords having the similar meanings among the keywords included in the keyword cluster information as the same cluster information, and determine, as the keywords appearing the most, keywords of the cluster information having a large number of keywords by comparing each of the number of keywords included in each piece of cluster information. The server 10 may extract keyword information including the keywords that is belonged to cluster information and determined to be the keywords appearing the most. In addition, the server 10 may extract not only the keywords appearing the most, but also the keyword cluster information of the classification corresponding to the lower classification information obtained in step S1′.

In step S5′, the server 10 may transmit the keyword information including the keyword cluster information of the classification corresponding to the keywords appearing the most extracted in step S4′ and the lower classification information obtained in step S1′.

The server 10 according to the preferred exemplary embodiment of the present disclosure may perform the obtaining of the keyword information in step S30′ according to the first or second exemplary embodiment as described above.

Then, as shown in FIG. 4, in step S40′, the server 10 may transmit the obtained keyword information to the terminal 1.

In step S50′, the server 10 may receive keyword input information obtained from the terminal 1 according to a user selection signal for the keyword information transmitted to the terminal 1 in step S40′.

In step S60, the server 10 may obtain first patent search result information for the received keyword input information. Describing in detail, the server 10 may perform a patent search by using the received keyword input information. The server 10 may receive the keyword input information from the terminal 1 and combine keywords included in the keyword input information with a search formula pre-stored in the server memory unit 10a. In this case, the server 10 may write keywords included in the same cluster information in combination with an OR among the keywords included in the keyword input information received from the terminal 1, and write keywords included in other cluster information in combination with an AND. The server 10 may perform a patent search in a selected classification range by using the search formula prepared by combining the keywords, which are included in the keyword input information, with the pre-stored search formula. The server 10 may obtain the first patent search result information through such a process.

The first patent search result information may be result information obtained by performing a search on the patent document information, which is stored in the server memory unit 10a, by using the keyword information selected by the user. The representative image information corresponding to the first patent search result information is representative image information representing each piece of the patent document information included in the first patent search result information, and may be any one of patent drawings attached to each patent document.

In step S70′, the server 10 may extract representative image information corresponding to the first patent search result information. The first patent search result information is information including patent documents, which are searched using the patent search formula. The server 10 may extract the representative image information of each of the patent documents included in the first patent search result information.

In step S80′, the server 10 may transmit the representative image information extracted in step S70′ to the terminal 1.

In step S90′, the server 10 may obtain patent document information corresponding to the representative image information selected by a user selection signal from the terminal 1. Describing in detail, the server 10 may receive, from the terminal 1, at least one or more pieces of representative image information selected by the user selection signal among the pieces of representative image information displayed on the terminal 1. The server 10 may obtain the patent document information including the received representative image information. As an example, in the server 10, the representative image information representing the patent documents may include metadata. The metadata may include an identification number of each patent document (e.g., a registration number and/or publication number of the patent document, etc.). The server 10 may obtain the patent document information of the received representative image information by using the metadata included in the representative image information.

In step S100′, the server 10 may obtain second patent search result information based on the patent document information obtained in step S90′. By using the patent document information obtained in step S90′, the server 10 may obtain keyword cluster information of the corresponding patent document information from the server memory unit 10a. In addition, the server 10 may obtain keyword cluster information of the corresponding citing and/or cited patent document information through the server memory unit 10a by using the citing and/or cited patent document information included in the patent document information obtained in step S90′.

The second patent search result information is information on patent documents similar to the patent documents selected in the previous step. To this end, the second patent search result information may be searched from the patent document information stored in the server memory unit 10a on the basis of the patent document information selected by the user in the previous step.

As the exemplary embodiment, the second patent search result information may be result information searched from the pieces of patent document information stored in the server memory unit 10a by using an invention title, as a keyword, among the field items of the patent document information selected in the previous step. In this case, the second patent search result information may include patent documents searched in the field for invention titles of the pieces of patent document information stored in the server memory unit 10a by using the invention title, as the keyword, among the field items of the patent document information selected in the previous step.

Alternatively, the second patent search result information may be result information searched from the pieces of patent document information stored in the server memory unit 10a by using a component name shown in a drawing, as a keyword, among the field items of the patent document information selected in the previous step. In this case, the second patent search result information may include patent documents searched in the field for invention titles of the patent document information stored in the server memory unit 10a by using the component name shown in the drawing, as the keyword, among the field items of the patent document information selected in the previous step.

The server 10 may perform a process of searching for patent documents including keywords included in the corresponding keyword cluster information by using the keyword cluster information obtained based on the patent document information obtained in step S90′. Accordingly, the server 10 may obtain second patent search result information.

In step S110′, the server 10 may extract representative image information of the patent documents included in the second patent search result information obtained in step S100′.

In step S120′, the server 10 may transmit the extracted representative image information to the terminal 1.

The server 10 may iteratively perform steps S90′ to S120′ until the number of pieces of representative image information selected in the terminal 1 reaches a specific number preset in the server 10. Specifically, the server 10 may return to step S90′ after performing step S120′. Then, the server 10 may sequentially re-perform steps S100′ to S120′.

The server 10 may transmit the question information of step S130 when the number of pieces of representative image information selected by a user selection signal through the terminal 1 reaches a specific number. The server 10 may preset information on the specific number to perform step S130. Specifically, in the server 10, the information on the specific number may be set so that the question information is transmitted when the number of pieces of representative image information selected and received by a user selection signal reaches the specific number. For example, the server 10 may preset information on a specific number as a number n, such as 10 or 15.

While iteratively performing steps S90′ and S120′, the server 10 may obtain question information including sentence information and yes-or-no information, which are stored in the server memory unit 10a, when the number of pieces of selected representative image information reaches the specific number preset in the server 10.

For example, in the server 10, the specific number information may be preset as 15. When the number of pieces of representative image information that is selected reaches 15, the server 10 may transmit the 15 pieces of representative image information to the terminal 1 collectively.

In step S130, the server 10 may transmit the obtained question information to the terminal 1. As an example, the server 10 may transmit “Is there an idea you thought of here?” of sentence information and “YES” or “NO” of yes-or-no information.

In this case, as an example, before transmitting the question information of step S130, the server 10 may collectively transmit the obtained 15 pieces of representative image information, which are obtained while iteratively performing steps S90′ to S120′, to the terminal 1. However, the sequence of the process of collectively transmitting the specific number of pieces of representative image information to the terminal 1 is not limited thereto.

As another example, after transmitting the sentence information of the question information to the terminal 1 in step S130, the server 10 may transmit the specific number of pieces of representative image information to the terminal 1, and may also transmit the yes-or-no information.

In step S140, the server 10 may receive answer information corresponding to the question information transmitted in step S130. The answer information may be answer information corresponding to the yes-or-no information of the question information.

In step S150, the server 10 may determine whether to repeat a search based on the answer information.

Describing in detail, in step S140, in a case of receiving the answer information of YES, the server 10 may determine that the patent searched for by the user has been provided. Accordingly, the server 10 may perform the next step, that is, step S160, without repeating the search. In step S140, the server 10 may receive the answer information of YES and receive selection patent image information. The selection patent image information may be representative image information, which is selected by a user selection signal, among the representative image information collectively displayed on the terminal 1.

In step S160, on the basis of selection patent image information, the server 10 may obtain patent document information including the selection patent image information. The selection patent image information may include, as metadata, an identification number of the patent document information including the selection patent image information. The server 10 may obtain the patent document information including the selection patent image information by using the metadata. Then, the server 10 may extract additional information of the patent document information including the selection patent image information. The server 10 may transmit the additional information of the patent document information to the terminal 1. The additional information of the patent document information transmitted from the server 10 to the terminal 1 may be result information corresponding to the answer information of YES.

The server 10 may transmit the additional information of the patent document information to the terminal 1 and transmit search completion confirmation information.

Describing in detail, the server 10 may transmit the additional information of the patent document information to the terminal 1, and then receive a final information display signal from the terminal 1. Then, the server 10 may obtain the search completion confirmation information on the basis of the final information display signal. The search completion confirmation information may include question information and yes-or-no information.

The server 10 may perform an end step when receiving YES information among the yes-or-no information of the search completion confirmation information.

Meanwhile, in a case of receiving NO information among the yes-or-no information of the search completion confirmation information, the server 10 may perform the same process as in the case of receiving the answer information of NO in step S140.

In step S140, in the case where the server 10 receives the answer information of NO, a detailed process performed by the server 10 is described as follows.

In a case where the answer information of NO is received in step S140, the server 10 may determine search repetition on the basis of the answer information in step S150.

In step S150, after determining to repeat the search, the server 10 may iteratively perform steps S90′ to S120′, and may perform a patent document search on the basis of the patent document information including the specific number of pieces of representative image information that is obtained. The process of performing the patent document search in step S150 may be the same as the process of performing the patent document search for obtaining the second patent search result information in step S100′. The server 10 may obtain third patent search result information through such a process.

In a case where the patent document information including the specific number of pieces of representative image information obtained by iteratively performing steps S90′ to S120′ is included in the third patent search result information, the server 10 may perform a process of filtering redundantly searched patent document information. The server 10 may filter out the redundant patent document information from the third patent search result information by using the metadata included in the representative image information. The server 10 may transmit, to the terminal 1, only the third patent search result information from which the redundant patent document information is excluded.

Specifically, the server 10 may extract representative image information of patent documents included in the obtained third patent search result information and then transmit the extracted information to the terminal 1. Then, the server 10 may re-perform step S130. The server 10 may sequentially re-perform steps S130 to S150.

After obtaining the specific number of pieces of representative image information, the server 10 according to the preferred exemplary embodiment of the present disclosure may repeat the process of performing a patent document search on the basis of the patent document information including the specific number of pieces of representative image information. The server 10 according to the preferred exemplary embodiment of the present disclosure may implement a method of narrowing down from a wide range of searching for patents to a range of searching for similar patents through such a process. The server 10 according to the preferred exemplary embodiment of the present disclosure may provide a patent document including the same concept as the idea the user desires to find by using such a method.

In other words, according to the preferred exemplary embodiment of the present disclosure, the server 10 may perform steps up to the obtaining of the specific number of pieces of representative image information, thereby narrowing down from the wide range of searching for patents to the range of searching for patents including the concept similar to the idea that the user desires to find.

More specifically, the server 10 according to the preferred exemplary embodiment may provide the search range of patents including the similar concept by obtaining the specific number of pieces of representative image information. After determining the search range of the patents including the similar concept, the server 10 according to the preferred exemplary embodiment of the present disclosure may narrow down the patent search range from the search range of corresponding patents to the search range of the patents including much more similar concept. As such, the server 10 according to the preferred exemplary embodiment of the present disclosure may obtain and provide patent documents including the same concept as the idea the user desires to find through the method of gradually narrowing down from the range of searching for similar patents to the range of searching more similar patents.

In addition, the server 10 according to the preferred exemplary embodiment of the present disclosure may extract and provide representative images corresponding to searched patent results. For this reason, the server 10 according to the preferred exemplary embodiment of the present disclosure may enable visual comparison to be made easily between the idea that the user desires to find and the search results. As a result, anyone may be able to easily obtain the patent search results including similar and/or identical concept to the idea one has in mind.

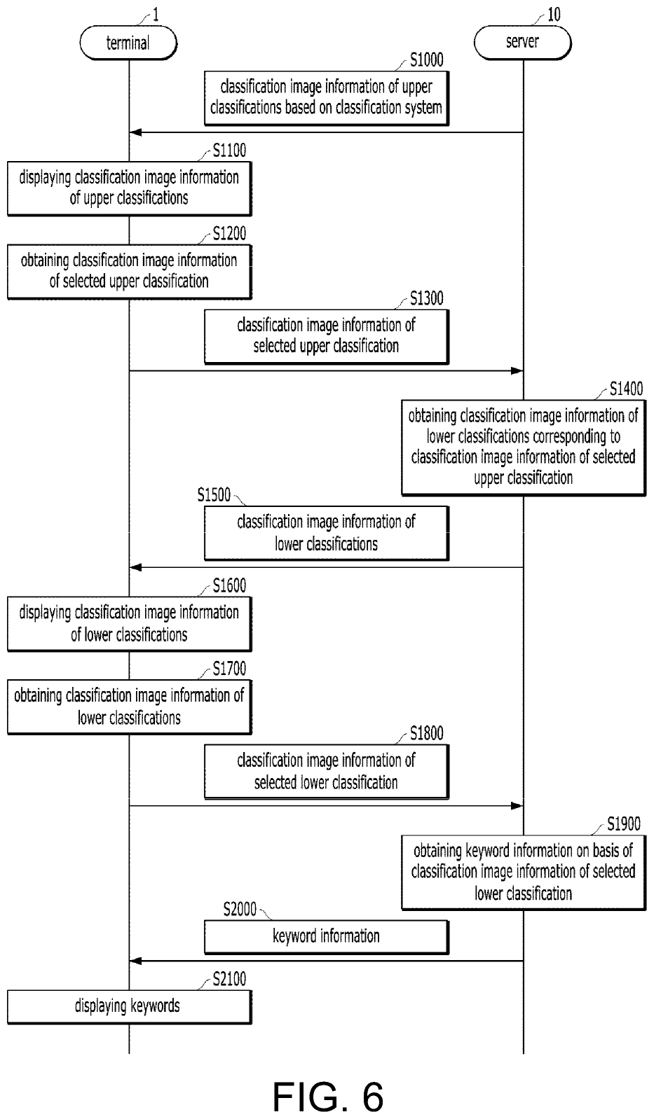

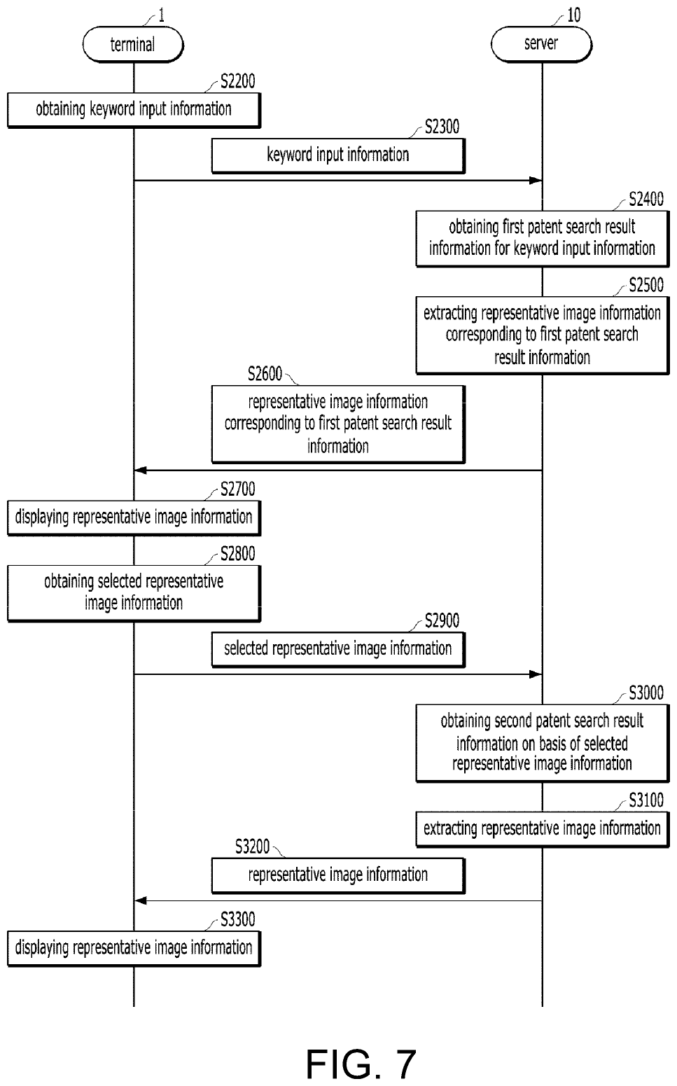

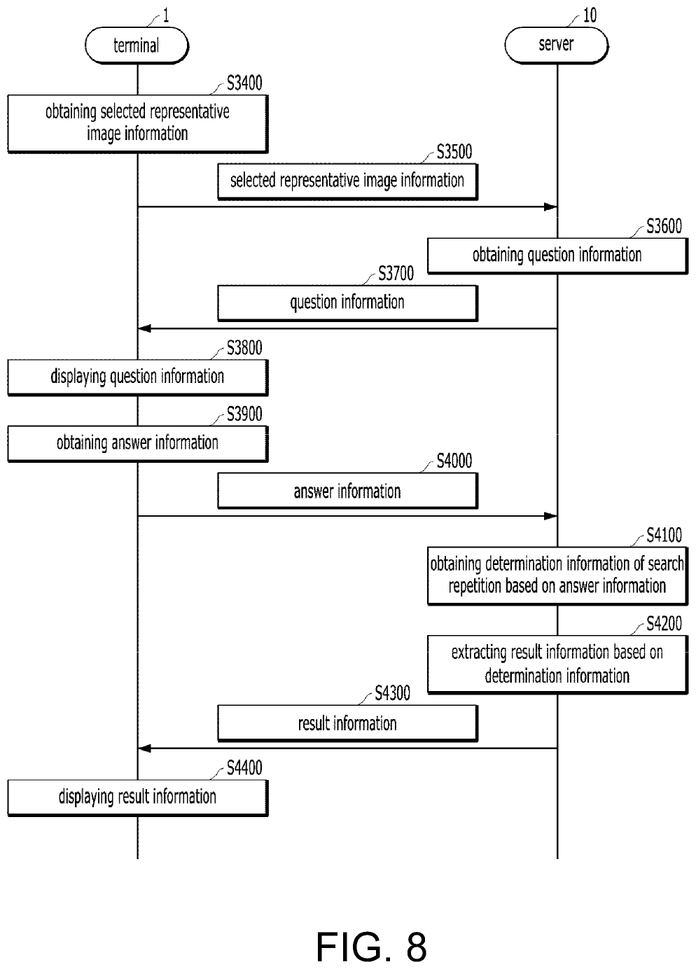

FIGS. 6 to 8 are flowcharts of a control method of the patent search system according to the preferred exemplary embodiment of the present disclosure. The control method of the patent search system according to the preferred exemplary embodiment of the present disclosure may be configured to include: a control method of a terminal 1 according to the preferred exemplary embodiment of the present disclosure; and a control method of a server 10 according to the preferred exemplary embodiment of the present disclosure. Accordingly, a detailed description of each step constituting the control method of the patent search system according to the preferred exemplary embodiment of the present disclosure refers to the above description instead, and will thus be omitted.

The control method of the patent search system according to the preferred exemplary embodiment of the present disclosure may be configured to include: transmitting, by a server 10, classification image information based on a classification system to a terminal 1; receiving, by the terminal 1, the classification image information; transmitting, by the terminal 1, selected classification image information to the server 10; obtaining, by the server 10, keyword information on the basis of the selected classification image information; transmitting, by the server 10, the keyword information to the terminal 1; obtaining, by the terminal 1, keyword input information; transmitting, by the terminal 1, the keyword input information to the server 10; obtaining, by the server 10, first patent search result information on the basis of keywords included in the keyword input information; extracting, by the server 10, representative image information corresponding to the first patent search result information; and transmitting, by the server 10, the representative image information to the terminal 1.

The control method of the patent search system according to the preferred exemplary embodiment of the present disclosure will be described in detail with reference to FIGS. 6 to 8.

As shown in FIG. 6, in step S1000, a server 10 may transmit classification image information based on a classification system to a terminal 1. As an example, the classification system may be a patent classification system. The server 10 may transmit the classification image information of upper classifications based on the patent classification system to the terminal 1.

In step S1100, the terminal 1 may display the classification image information received from the server 10.

Specifically, the terminal 1 may display the classification image information of the upper classifications received from the server 10.

In step S1200, from among the displayed classification image information of the upper classifications, the terminal 1 may obtain classification image information of one upper classification selected by a user selection signal.

In step S1300, the terminal 1 may transmit the classification image information of the upper classification obtained in step S1200 to the server 10.

In step S1400, the server 10 may obtain classification image information of lower classifications corresponding to the received classification image information of the upper classification.

In step S1500, the server 10 may transmit the classification image information of the lower classifications obtained in step S1400 to the terminal 1.

In step S1600, the terminal 1 may display the received classification image information of the lower classifications.

In step S1700, from among the displayed classification image information of the lower classifications, the terminal 1 may obtain classification image information of one lower classification selected by a user selection signal.

In step S1800, the terminal 1 may transmit the classification image information of the obtained lower classification in step S1700 to the server 10.

By the terminal 1, starting from uppermost classifications of the classification system up until lowermost classifications are selected and classification image information of the lowermost classifications are transmitted to the server 10, the patent search system according to the preferred exemplary embodiment of the present disclosure may iteratively perform steps S1000 to S1800.

In step S1900, the server 10 may obtain keyword information on the basis of the received classification image information of the lower classification. Specifically, the classification image information of the lower classification received by the server 10 may be classification image information of a lowermost classification of the classification system.

In step S2000, the server 10 may transmit the obtained keyword information to the terminal 1.

In step S2100, the terminal 1 may display the received keyword information.

In step S2200, the terminal 1 may obtain keyword input information by a user selection signal for the displayed keyword information.

In step S2300, the terminal 1 may transmit the obtained keyword input information to the server 10.

In step S2400, the server 10 may obtain first patent search result information for the keyword input information received through step S2300. By using a search formula pre-stored in a server memory unit 10a, the server 10 may write keywords, included in the keyword input information, in the search formula.

In step S2500, the server 10 may extract representative image information corresponding to first patent search result information.

In step S2600, the server 10 may transmit the representative image information corresponding to the first patent search result information extracted in step S2500.

In step S2700, the terminal 1 may display the representative image information corresponding to the first patent search result information.

In step S2800, from among the representative image information corresponding to the displayed first patent search result information, the terminal 1 may obtain representative image information selected by a user selection signal.

In step S2900, the terminal 1 may transmit the selected representative image information to the server 10.

In step S3000, on the basis of the selected representative image information, the server 10 may obtain patent document information including the selected representative image information, and may obtain second patent result information by performing a patent search on the basis of the obtained patent document information.

In step S3100, the server 10 may extract representative image information corresponding to the second patent search result information.

In step S3200, the server 10 may transmit the representative image information corresponding to the second patent search result information extracted in step S3100 to the terminal 1.

In step S3300, the terminal 1 may display the representative image information corresponding to the second patent search result information received through step S3200.

In step S3400, from among the representative image information corresponding to the displayed second patent search result information, the terminal 1 may obtain representative image information selected by a user selection signal.

In step S3500, the terminal 1 may transmit the obtained representative image information to the server 10.

The patent search system according to the preferred exemplary embodiment of the present disclosure may iteratively perform steps S3000 to S3500, and obtain representative image information as many as a specific number thereof preset in the server 10.

Then, in step S3600, the server 10 may obtain question information. The question information may include sentence information and yes-or-no information.

In step S3700, the server 10 may transmit the obtained question information to the terminal 1.

In step S3800, the terminal 1 may display the received question information.

In step S3900, the terminal 1 may obtain answer information through the yes-or-no information of the displayed question information.

In step S4000, the terminal 1 may transmit the obtained answer information to the server 10.

In step S4100, the server 10 may obtain information to determine whether to repeat a search on the basis of the obtained answer information.

Specifically, in a case where the obtained answer information is YES, the server 10 may determine that search repetition is not to be performed, and then perform the next step.

Meanwhile, in a case where the obtained answer information is NO, the server 10 may determine that search repetition is to be performed. In this case, the server 10 may perform a search on the basis of each piece of patent document information corresponding to the specific number of pieces of representative image information obtained by the patent search system iteratively performing steps S3000 to S3500 and in accordance with the preferred exemplary embodiment of the present disclosure. The server 10 may obtain third patent search result information through such a process.

In step S4200, the server 10 may extract result information based on determination information. Specifically, the server 10 may extract, as the result information, additional information of the patent document information including selection patent image information selected in the terminal 1 in response to the determination information according to the answer information of YES.

Meanwhile, the server 10 may obtain the third patent search result information in response to the determination information according to the answer information of NO, and correspondingly extract representative image information as the result information.

In step S4300, the server 10 may transmit the extracted result information to the terminal 1.

In step S4400, the terminal 1 may display the received result information.

The terminal 1 may display final information of the result information corresponding to the answer information of YES, and then transmit a final information display signal to the server 10.

The server 10 may receive the final information display signal and transmit search completion confirmation information to the terminal 1. In a case where the server 10 obtains the answer information of NO among the search completion confirmation information from the terminal 1, the server 10 may return from step S4100 to the step of performing the search repetition according to the answer information of NO.

Then, the server 10 may perform a new patent search on the basis of each piece of patent document information corresponding to the specific number of pieces of representative image information, and obtain new patent search result information.

Then, the server 10 may sequentially re-perform steps S3600 to S4400 until receiving the answer information of YES from among the search completion confirmation information.

The patent search system according to the preferred exemplary embodiment of the present disclosure may be terminated when the server 10 receives the answer information of YES among the search completion confirmation information from the terminal 1.

The patent search system of the present disclosure is characterized by tracking and searching for the idea of which the user is thinking merely by user's selection act, and may be configured to include: limiting the search target range through the user's selection act by using the hierarchical classification system of patent documents; and extracting the similar patents through the user selection in the limited search target range.

The patent search system of the present disclosure first limits the search target range through the user's selection act, and then performs the step of extracting similar patents through the user's selection act in the limited search target range.

Here, the limiting of the search target range by using the hierarchical classification system of patent documents is the step of narrowing down the search target range by including the step of receiving the plurality of pieces of classification image information based on the classification system from the server 10 and transmitting the classification image information selected from the plurality of pieces of classification image information, which is presented. The user using the patent search system of the present disclosure may narrow down the search target range by selecting any one classification image related to the idea of which the user is thinking among the plurality of pieces of classification image information provided from the terminal 1.

In addition, when the limiting of the search target range is completed, the step of extracting the similar patents from the limited search target range is performed. The extracting of the similar patents in the limited search target range is the step of extracting the similar patents by using the keyword information extracted from the pieces of patent document information belonging to the finally selected classification. By performing the search for the similar patents on the basis of the patent document information selected by the user from among the plurality of pieces of patent document information provided from the terminal 1, a patent related to the idea of which the user is thinking may be tracked and searched for.

The conventional patent search system adopts the configuration in which a user inputs specific keywords by using a keyword keyboard to search for a patent related to the idea the user has in mind. Whereas, the patent search system of the present disclosure adopts the configuration in which the patent related to the idea the user has in mind is searched merely by the user's selection act for selecting the classification image information or keywords, which are presented through a display unit of a terminal. As a result, in the patent search system according to the preferred exemplary embodiment of the present disclosure, anyone can easily search for the ideas they desire to find even when they do not have the patent search knowledge required to obtain the patent search result.

As described above, although the present disclosure has been described with reference to the preferred exemplary embodiment, those skilled in the art may implement the present disclosure by various modifications or variations within the scope without departing from the spirit and scope of the present disclosure as set forth in the following claims.

### DESCRIPTION OF THE REFERENCE NUMERALS IN THE DRAWINGS

1: terminal
2: terminal control unit 6: terminal communication unit
8: terminal memory unit
10: server
10a: server memory unit 10b: server control unit
10c: server communication unit

1. A terminal for providing a patent search, the terminal comprising:
a terminal communication unit for transmitting and receiving information;
a terminal memory unit for storing the information; and
a terminal control unit for controlling the terminal communication unit and the terminal memory unit,
wherein through the terminal communication unit, the terminal control unit is configured to receive classification image information based on a classification system from a server, transmit selected classification image information to the server, receive keyword information from the server, transmit selected keyword information to the server, receive representative image information corresponding to first patent search result information corresponding to the keyword information from the server, and transmit selected representative image information to the server.

2. A control method of a terminal for providing a patent search, the control method of the terminal comprising:
receiving classification image information based on a classification system from a server;
transmitting selected classification image information to the server;
receiving keyword information from the server;
transmitting selected keyword information to the server;
receiving representative image information corresponding to first patent search result information corresponding to the keyword information from the server; and
transmitting selected representative image information to the server.

3. The control method of the terminal of claim 2, further comprising:
receiving representative image information corresponding to second patent search result information from the server;
receiving question information;
transmitting answer information corresponding to the question information; and
receiving result information corresponding to the answer information.

4. A server for providing a patent search, the server comprising:
a server communication unit for transmitting and receiving information;
a server memory unit for storing the information; and
a server control unit for controlling the server communication unit and the server memory unit,
wherein the server control unit is configured to transmit classification image information based on a classification system to a terminal through the server communication unit, obtain keyword information on the basis of selected classification image information through the server memory unit, transmit the keyword information to the terminal through the server communication unit, receive keyword input information from the terminal, obtain first patent search result information corresponding to the keyword input information through the server memory unit, extract representative image information corresponding to the first patent search result information, and transmit the representative image information to the terminal through the server communication unit.

5. A control method of a server for providing a patent search, the control method of the server comprising:
transmitting classification image information based on a classification system to a terminal;
receiving selected classification image information from the terminal;
obtaining keyword information on the basis of the selected classification image information;
transmitting the keyword information to the terminal;
receiving keyword input information from the terminal;
obtaining first patent search result information corresponding to the keyword input information;
extracting representative image information corresponding to the first patent search result information; and
transmitting the representative image information to the terminal.

6. The control method of the server of claim 5, further comprising:
obtaining patent document information corresponding to selected representative image information;
obtaining second patent search result information based on the patent document information;
transmitting representative image information corresponding to the second patent search result information to the terminal;
transmitting question information;
receiving answer information corresponding to the question information; and
transmitting result information corresponding to the answer information.

7. The control method of the server of claim 5, wherein the obtaining of the keyword information on the basis of the selected classification image information comprises:
obtaining lower classification information corresponding to the selected classification image information;
extracting keyword information including keywords of patent documents of the lower classification information obtained using pre-stored keyword cluster information; and
transmitting the extracted keyword information to the terminal.

8. The control method of the server of claim 5, wherein the obtaining of the keyword information on the basis of the selected classification image information comprises:
obtaining lower classification information corresponding to the selected classification image information;
classifying patent documents corresponding to the lower classification information;
obtaining keyword cluster information of the classified patent documents;
extracting keyword information including keywords appearing the most in the lower classification information on the basis of the keyword cluster information; and
transmitting the extracted keyword information to the terminal.

9. The control method of the server of claim 5, wherein, in the obtaining of the first patent search result information corresponding to the keyword input information, keywords included in a same cluster among keywords included in the keyword input information received from the terminal are written with an OR combination, and
keywords included in other clusters are written with an AND combination.

10. The control method of the server of claim 6, wherein, in the transmitting of the result information corresponding to the answer information, additional information of the patent document information including the answer information and received selection patent image information is transmitted to the terminal when the answer information is YES, and
third patent search result information is obtained and transmitted to the terminal on the basis of the patent document information including the question information and the collectively transmitted representative image information when the answer information is NO.

11. A patent search system comprising:
a terminal for providing a patent search; and
a server,
wherein the terminal comprises:
a terminal communication unit for transmitting and receiving information; and
a terminal control unit for controlling the terminal communication unit,
the terminal control unit is configured to receive classification image information based on a classification system from the server, transmit selected classification image information to the server, receive keyword information from the server, transmit selected keyword information to the server, receive representative image information corresponding to first patent search result information corresponding to the keyword information from the server, and transmit selected representative image information to the server through the terminal communication unit,
the server comprises:
a server communication unit for transmitting and receiving the information;
a server memory unit for storing and outputting the information; and
a server control unit for controlling the server communication unit and the server memory unit, and
the server control unit is configured to transmit the classification image information based on the classification system to the terminal through the server communication unit, obtain the keyword information on the basis of the selected classification image information through the server memory unit, transmit the keyword information to the terminal through the server communication unit, receive keyword input information from the terminal, obtain the first patent search result information corresponding to the keyword input information through the server memory unit, extract the representative image information corresponding to the first patent search result information, and transmit the representative image information to the terminal through the server communication unit.

12. A control method of a patent search system comprising a terminal and a server, which provide a patent search, the control method of the patent search system comprising:
transmitting, by the server, classification image information based on a classification system to the terminal;
receiving, by the terminal, the classification image information;
transmitting, by the terminal, selected classification image information to the server;
obtaining, by the server, keyword information on the basis of the selected classification image information;
transmitting, by the server, the keyword information to the terminal;
obtaining, by the terminal, keyword input information;
transmitting, by the terminal, the keyword input information to the server;
obtaining, by the server, first patent search result information on the basis of keywords included in the keyword input information;
extracting, by the server, representative image information corresponding to the first patent search result information; and
transmitting, by the server, the representative image information to the terminal.
